(19) United States
(12) Patent Application Publication
(10) Pub. No.: US 2026/0197421 A1
(43) Pub. Date: Jul. 9, 2026

(54) INFORMATION HANDLING SYSTEM WITH A SECURE CAMERA FUNCTION

(71) Applicant: DELL PRODUCTS L.P., Round Rock, TX (US)

(72) Inventors: Yung-Sheng Lin, Bade District (TW); Gregory Havenga, Lakeway, TX (US); Yao-Hsien Huang, Sanxia District (TW); Andelon Tra, Lago Vista, TX (US)

(21) Appl. No.: 19/014,069

(22) Filed: Jan. 8, 2025

(51) Int. Cl. H04N 7/18

(52) U.S. Cl. CPC H04N 7/18

(57) ABSTRACT

An information handling system includes a camera, a vision processor, and a processor. The camera capture multiple images associated with the information handling system. The vision processor caches the images. The processor receives an indication of an abnormal event for the information handling system. Based on the indication of the abnormal event, the processor creates a detected event video based on the cached images. The processor enhances the detected event video to create a good quality video. The processor stores the good quality video in a memory of the information handling system. The good quality video provides information associated with the abnormal event.

### FIELD OF THE DISCLOSURE

The present disclosure generally relates to information handling systems, and more particularly relates to securing a camera function within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a camera, a vision processor, and a processor. The camera may capture multiple images associated with the information handling system. The vision processor may cache the images. The processor may receive an indication of an abnormal event for the information handling system. Based on the indication of the abnormal event, the processor may create a detected event video based on the cached images. The processor may enhance the detected event video to create a good quality video. The processor may store the good quality video in a memory of the information handling system. The good quality video provides information associated with the abnormal event.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a perspective view of an information handling system according to at least one embodiment of the present disclosure;

FIG. 2 is a block diagram of an information handling system according to at least one embodiment of the present disclosure;

FIG. 3 is a flow diagram of a method for reducing a modern standby failure impact in an information handling system according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

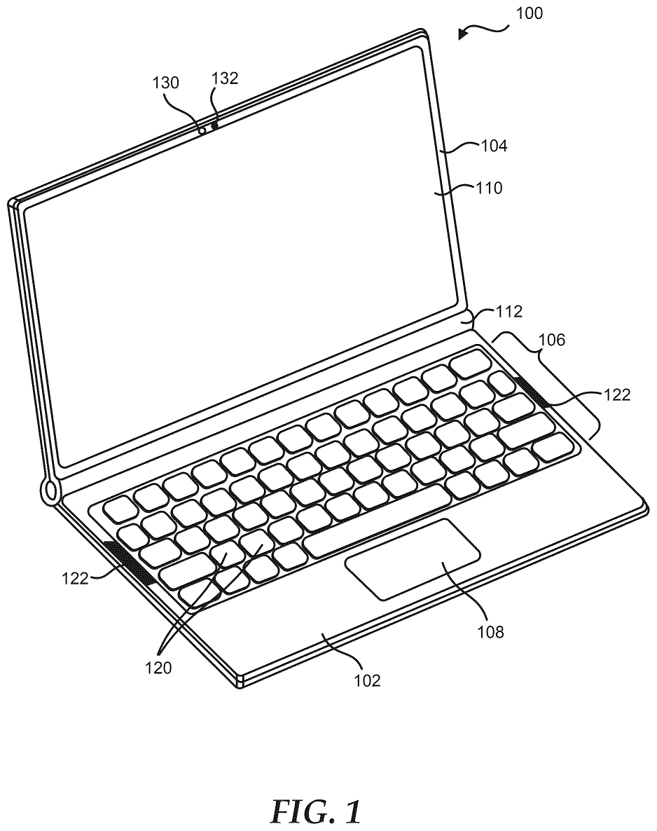

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a base portion 102 and a top 104. Base portion 102 includes a keyboard 106 and a touchpad 108, and top portion 104 includes a display device 110. In an example, touchpad 108 may be any suitable pointing device. Base portion 102 is connected top portion 104 via a mechanism 112, such as one or more hinges. Keyboard 106 includes multiple keys 120. Base portion 102 further includes speakers 122. Top portion 104 includes a camera 130 and a microphone 132. Information handling system 100 may include additional components without varying from the scope of the disclosure.

When the information handling system 100 includes a 2-in-1 device, mechanism 112 may enable the top portion 104 to be connected to bottom portion 102 for use as a laptop device and may enable the top portion 104 to be detached from bottom portion 102 to enable the top portion 104 to be used as a tablet information handling system. Display device 110 may include one or more light emitting devices, such as, for example, light emitting diodes (LEDs), organic LED (OLED), liquid crystal display (LCD), another type of light emitting device, or any combination thereof.

In certain examples, components within information handling system 100 may perform different operations to determine events within the information handling system. These events may include, but are not limited to, a free fall event, a shock event, and a hack event. In an example, information handling system 100 may utilize camera 130 to perform a user presence detection (UPD) as a security feature, event documentation, or the like. In previous information handling systems, the camera and some software within information handling system may provide this security feature, but the camera may consume more power from normal camera solution. In an example, camera 130 may be a UPD camera that consumes low power based on its low resolution and low framerate. Information handling system 100 may be improved by utilizing a UPD camera, such as camera 130, to record images associated with detected events, and processing the recorded images to improve image/video quality. This improved image/video quality may ensure good enough image quality for event documentation as will be described herein.

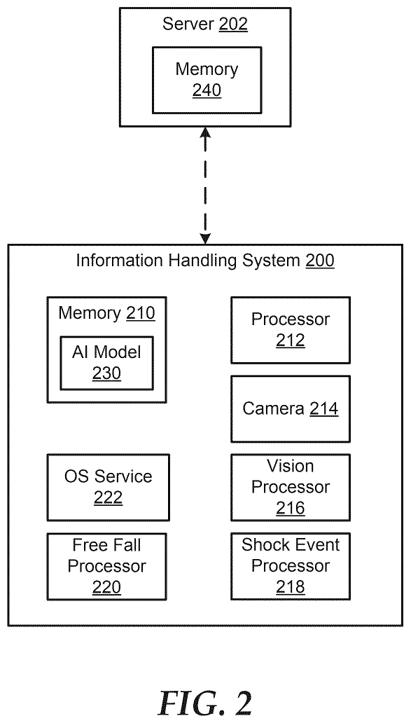

FIG. 2 shows a system including a portion of an information handling system 200 and a portion of a server 202 according to at least one embodiment of the present disclosure. Information handling system 200 may be suitable similar to information handling system 100 of FIG. 1. Information handling system 200 includes a memory 210, a processor 212, a camera 214, a vision processor 216, a shock event processor 218, a free fall processor 220, and operating system (OS) services 222. Information handling system 200 may store any suitable data including, but not limited to, an artificial intelligence (AI) model 230. Server 202 includes a memory 240. Both of information handling system 200 and server 202 may include additional components without varying from the scope of this disclosure.

In certain examples, an individual may take or use information handling system 200 in different locations, such as an office, a cubicle, a conference room, a coffee shop, or the like. During use of information handling system 200, one or more abnormal events may be detected by processor 212, camera 214, vision processor 216, shock event processor 218, free fall processor 220, or the like. In an example, an abnormal event may occur while the individual is moving information handling system 200 between locations. For example, the abnormal event may result from information handling system 200 being dropped, the information handling system being hit on a door or wall, or the like. The abnormal event may be someone other than the user of information handling system 200 accessing the information handling system, being located near the information handling system while the user is not, or the like.

Depending on the abnormal event, a different one of processor 212, camera 214, vision processor 216, shock event processor 218, free fall processor 220 may detect the event. In an example, camera 214 and vision processor 216 may monitor whether an individual, other than the user of information handling system 200, has accessed the information handling system, is near the information handling system while the user is away, or the like. In certain examples, vision processor 216 or processor 212, via AI model 230, may perform one or more operations to recognize that the individual in front of information handling system 200 is not the individual associated with the information handling system. User presence detection (UPD) by vision processor 216 is well known in the art and will not be described in detail except to describe embodiments of the disclosure herein.

In an example, shock event processor 218 may detect an abnormal shock event, such as information handling system 100 being hit against a hard surface. The hard surface may be a door frame, a table, or the like. Detection of an abnormal shock event by shock event processor 218 is well known in the art and will not be described in detail except to describe embodiments of the disclosure herein.

In certain examples, free fall processor 220 may be any suitable component to monitor whether information handling system 200 is in an abnormal free fall event. In an example, free fall processor 220 may be any suitable component, such as an accelerometer, to measure or detect whether information handling system 100 is dropping in a free fall event. Detection of a free fall event by free fall processor 220 is well known in the art and will not be described in detail except to describe embodiments of the disclosure herein.

In an example, camera 214 may capture low resolution images, which vision processor 216 may receive from the camera and cache in a temporary buffer. While camera 214 is capturing the low resolution images, vision processor 216 may operate in a low power mode, such that the continuous capturing and caching of the images may not consume a lot of the battery information handling system 200. In certain examples, the buffer may be located in any suitable location of information handling system 100. For example, the buffer may be an integrated circuit (IC) random access memory (RAM) buffer of vision processor 216. In an example, the IC RAM buffer may be a first-in-first-out (FIFO) buffer with a limited amount of storage that may store images for a particular amount of time, such as twenty seconds, thirty seconds, forty seconds, or the like. In this situation, the IC RAM buffer may only store images for a rolling amount of time.

In response to an abnormal event being detected, vision processor 216 may save a trigger point associated with the detected abnormal event. After the trigger point is stored, vision processor 216 may dump the set of images in IC RAM buffer and combine these images as a video file. In certain examples, the created video file may be a low resolution video based camera 214 capturing low resolution images. In response to the images being dumped and combined as a low resolution video file, vision processor 216 may provide the video file OS service 222 via any suitable communication path within information handling system 200. For example, vision processor 216 may utilize an I3C, a universal serial bus (USB) communication path, or the like to provide the video file to OS service 222. In certain examples, processor 212 may execute OS service 222 to perform the operations described herein as being performed by the OS service.

In response to OS service 222 of processor 212 receiving the low resolution video file, the OS service may input the video file into AI model 230. In certain examples, AI model 230 includes an input layer, one or more hidden layers, and an output layer. AI model 230 may be a pre-trained model. Upon receiving the video from OS service 222, AI model 230 may execute one or more hidden layers to enhance the low resolution image into a better quality image/video. In an example, AI model 230 may provide the generated image/video at the output layer and store the image/video within memory 210. In an example, the good quality video may be encrypted before being stored in memory 210. For example, the data of the good quality video may be encrypted using a user/owner key. In certain examples, the generated image/video may be linked to a trigger time associated with the detected abnormal event.

In an example, processor 212 may provide the generated image/video and the trigger time for the abnormal event to the individual associated with information handling system 200 via any suitable manner. For example, the generated image/video may be provided to the individual via a graphical user interface (GUI) on a display of information handling system 200. In an example, processor 212 may generate an electronic mail (email) message to notify the individual of the abnormal event. Processor 212 may receive an indication as whether to send the generated image/video to server 202. In certain examples, the video may be encrypted before being uploaded to server 202. For example, the video may be encrypted using a user/owner key of information handling system 200. In an example, if the video is sent to server 202, the video may be stored in memory 240 for later access. In certain examples, the video stored in memory 240 of server 202 may be utilized by one or more individuals to determine the cause of the abnormal event. These individuals may also utilize the video to determine a course of action to resolve any issues associated with the abnormal event.

In an example, if the abnormal event is camera 214 and vision processor 216 detecting an individual in the office while the user of information handling system 200 is away, the vision processor and processor 212 may perform the operations disclosed herein to detect this event and save a good quality video associated with the event. If the abnormal event is information handling system 200 being hit on a door and system damage occurs, a company IT individual may access the video from memory 240. Based on the recorded video, this individual may be able clarify the damage to information handling system 200. In an example, if the abnormal event is camera 214 and vision processor 216 detecting an individual accessing information handling system 200 while the user of the information handling system is away, the vision processor and processor 212 may perform the operations disclosed herein to detect this event and save a good quality video associated with the event.

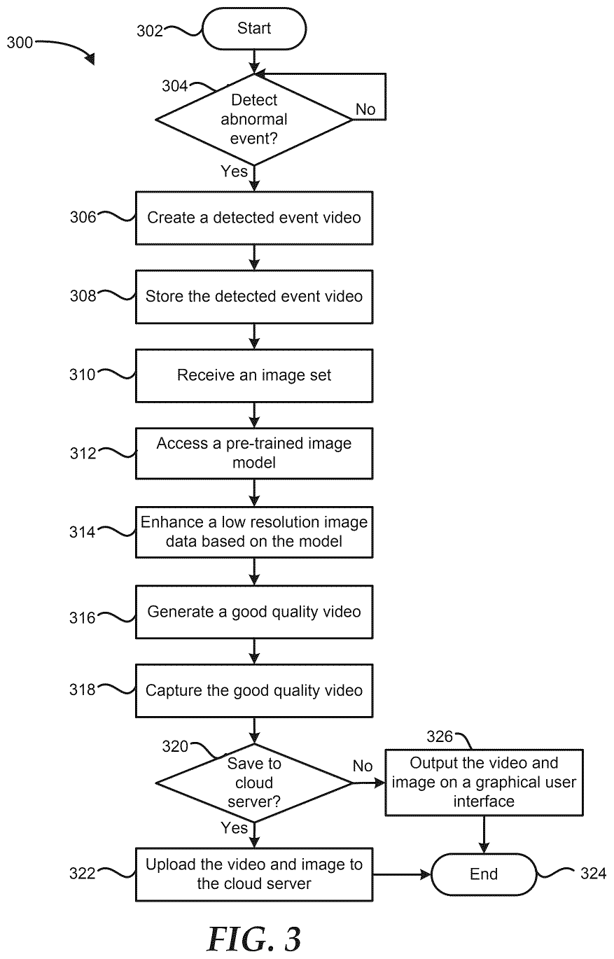

FIG. 3 shows a method 300 for reducing a modern standby failure impact in an information handling system according to at least one embodiment of the present disclosure, starting at block 302. Not every method step set forth in this flow diagram is always necessary, and certain steps of the methods may be combined, performed simultaneously, in a different order, or perhaps omitted, without varying from the scope of the disclosure. FIG. 3 may be employed in whole, or in part, processor 212, vision processor 216, shock event processor 218, free fall processor 220, and AI model 130 of information handling system 200 of FIG. 2, or any other type of controller, device, module, processor, or any combination thereof, operable to employ all, or portions of, the method of FIG. 3.

At block 304, a determination is made whether an abnormal event associated with an information handling system has been detected. The abnormal event may be any suitable event including, but not limited to, a free fall event, a shock event, and unauthorized access of the information handling system or office the information handling system is located in. In an example, the abnormal event may be detected by any suitable component within the information handling system, such as a vision processor, a shock event processor, a free fall processor, or the like.

In response to an abnormal event being detected, a detected event video is created at block 306. In an example, the detected event video may be created based on multiple images cached in a buffer. In certain examples, the buffer may cache images for a particular amount of time. For example, the buffer may be a FIFO buffer such that when the buffer is full as a new image is received the first image stored in the buffer is removed from buffer. In an example, the images stored in the buffer may be low resolution images, such that an amount of storage in the buffer may be reduced as compared to high resolution images.

At block 308, the detected event video is stored. In an example, the detected event video may be stored in a memory of the information handling system. The detected event video may be a low resolution video based on the images in the buffer, and may include video images before and after the abnormal event. In certain examples, the abnormal event may be substantially in the middle of the detected event video.

At block 310, an image set is received. In an example, the image set may be a group of images directly associated with a time of the abnormal event. For example, the image set may be still images captured a predetermined amount of time before the abnormal event, at the time of the abnormal event, and a predetermined amount of time after the abnormal event. At block 312, a pre-trained image model is accessed. The pre-trained image model may be accessed and executed by a processor of the information handling system. In an example, the pre-trained image model is an AI model

Based on the pre-trained image model, low resolution image data is enhanced at block 314. The execution of the pre-trained model by the processor may enable the processor to enhance the quality of the detected event video. At block 316, a good quality video is generated. In an example, the good quality video may be substantially better than the low resolution video created from the images in the buffer. At block 318, the good quality video is captured or stored. In certain examples, the good quality video may be stored in a memory of the information handling system. In an example, the good quality video may be encrypted before being stored in the memory. For example, the data of the good quality video may be encrypted using a user/owner key.

At block 320, a determination is made whether to save the good quality video to a server. This determination may be made by the processor in any suitable way. For example, the video may be provided to an individual associated with the information handling system via an electronic mail message or the like, and the processor may receive a response as to whether the video should be uploaded to a server. If the video is to be saved in the server, the video is uploaded to the server at block 322 and the flow ends at block 324. In an example, the video may be uploaded to the server based on the reception of a provide video notification. In certain examples, the video may be encrypted before being uploaded to the server. For example, the video may be encrypted using a user/owner key. If the video is not to be saved in the server, the video and image are output to a graphical user interface at block 326 and the flow ends at block 324. In an example, the video may not be uploaded to the server based on the reception of a do not provide video notification.

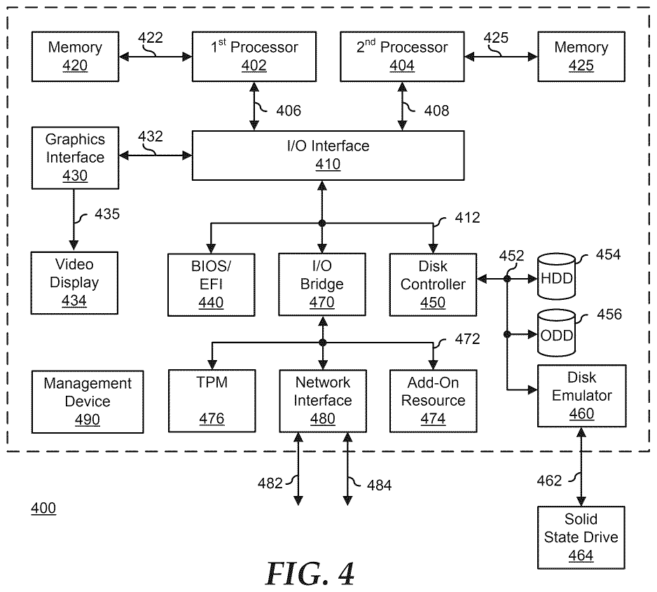

FIG. 4 shows a generalized embodiment of an information handling system 400 according to an embodiment of the present disclosure. Information handling system 400 may be substantially similar to information handling system 100 of FIG. 1 and information handling system 200 of FIG. 2. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a camera to capture a plurality of images associated with the information handling system;
a vision processor to communicate with the camera and to cache the images; and
a processor to communicate with the vision processor, the processor to:
receive an indication of an abnormal event for the information handling system;
based on the indication of the abnormal event, create a detected event video based on the cached images;
enhance the detected event video to create a good quality video; and
store the good quality video in a memory of the information handling system, wherein the good quality video provides information associated with the abnormal event.

2. The information handling system of claim 1, further comprising:
a free fall processor to determine whether a free fall event has occurred in the information handling system; and
in response to a detected free fall event, provide the indication of the abnormal event to the processor, wherein the abnormal event is the detected free fall event.

3. The information handling system of claim 1, further comprising:
a shock event processor to determine whether a shock event has occurred in the information handling system; and
in response to a detected shock event, provide the indication of the abnormal event to the processor, wherein the abnormal event is the detected shock event.

4. The information handling system of claim 1, wherein the vision processor further to:
determine whether another individual other than a user of the information handling system has accessed the information handling system; and
in response to the another individual having accessed the information handling system, provide the indication of the abnormal event to the processor, wherein the abnormal event is the another individual having accessed the information handling system.

5. The information handling system of claim 1, wherein prior to reception of the indication of the abnormal event, the vision processor operates in a low power mode.

6. The information handling system of claim 1, wherein the processor further to: execute an image model to enhance the detected event video.

7. The information handling system of claim 1, wherein the processor further to:
determine whether to provide the good quality video to a server; and
in response to reception of a provide video notification, transmit the good quality video to the server.

8. The information handling system of claim 7, wherein in response to reception of a provide video notification, the processor to provide the good quality video for output on a graphical user interface of the information handling system.

9. The information handling system of claim 1, wherein the detected event video is a low resolution video.

10. A method comprising:
capturing, by a camera of an information handling system, a plurality of images associated with the information handling system;
caching, by a vision processor of the information handling system, the images;
receiving an indication of an abnormal event for the information handling system;
based on the indication of the abnormal event, creating a detected event video based on the cached images;
enhancing the detected event video to create a good quality video; and
storing the good quality video in a memory of the information handling system, wherein the good quality video provides information associated with the abnormal event.

11. The method of claim 10, further comprising:
determining, by a free fall processor of the information handling system, whether a free fall event has occurred in the information handling system; and
in response to a detected free fall event, providing the indication of the abnormal event to the processor, wherein the abnormal event is the detected free fall event.

12. The method of claim 10, further comprising:
determining, by a shock event processor of the information handling system, whether a shock event has occurred in the information handling system; and
in response to a detected shock event, providing the indication of the abnormal event to the processor, wherein the abnormal event is the detected shock event.

13. The method of claim 10, further comprising:
determining whether another individual other than a user of the information handling system has accessed the information handling system; and
in response to the another individual having accessed the information handling system, providing the indication of the abnormal event to the processor, wherein the abnormal event is the another individual having accessed the information handling system.

14. The method of claim 10, wherein prior to reception of the indicating of the abnormal event, the vision processor operates in a low power mode.

15. The method of claim 10, further comprising: executing an image model to enhance the detected event video.

16. The method of claim 10, further comprising:
determining whether to provide the good quality video to a server; and
in response to reception of a provide video notification, transmitting the good quality video to the server.

17. The method of claim 16, wherein in response to receiving of a provide video notification, providing the good quality video for output on a graphical user interface of the information handling system.

18. The method of claim 10, wherein the detected event video is a low resolution video.

19. An information handling system comprising:
a camera to capture a plurality of images associated with the information handling system;
a vision processor to communicate with the camera and to cache the images;
a processor to:
receive an indication of an abnormal event for the information handling system;
based on the indication of the abnormal event, create a detected event video based on the cached images;
enhance the detected event video to create a good quality video; and
store the good quality video in a memory of the information handling system, wherein the good quality video provides information associated with the abnormal event;
a free fall processor to:
determine whether a free fall event has occurred in the information handling system; and
in response to a detected free fall event, provide the indication of the abnormal event to the processor, wherein the abnormal event is the detected free fall event;
a shock event processor to:
determine whether a shock event has occurred in the information handling system; and
in response to a detected shock event, provide the indication of the abnormal event to the processor, wherein the abnormal event is the detected shock event.

20. The information handling system of claim 19, wherein the processor further to:
determine whether to provide the good quality video to a server; and
in response to reception of a provide video notification, transmit the good quality video to the server.
